(19) United States
(12) Patent Application Publication
(10) Pub. No.: US 2014/0195302 A1
(43) Pub. Date: Jul. 10, 2014

(54) GUIDED WALKTHROUGH PROVIDER

(71) Applicant: ORACLE INTERNATIONAL CORPORATION, Redwood Shores, CA (US)

(72) Inventors: John E. YOPP, Minneapolis, MN (US); Charles T. PILON, Saint Paul, MN (US)

(73) Assignee: ORACLE INTERNATIONAL CORPORATION, Redwood Shores, CA (US)

(21) Appl. No.: 13/738,231

(22) Filed: Jan. 10, 2013

(51) Int. Cl. G06Q 30/02

(52) U.S. Cl. CPC G06Q 30/0204
USPC 705/7.33

(57) ABSTRACT

A system for providing a guided walkthrough of a retail store to a user. The system receives at least one criteria. The at least one criteria defines a customer segment. The customer segment corresponds to a set of customers of the store. The system also determines a representative path. The representative path is determined based upon paths previously taken through the store by the set of customers. The system also transmits instructions to guide the user along the representative path.

### FIELD

One embodiment is directed generally to a computer system, and in particular to a computer system that provides a guided walkthrough of a retail store.

### BACKGROUND INFORMATION

Customers may visit and directly purchase goods from retail stores. Because a retail store sells goods directly to customers through the customer's interaction with the store, retailers are often concerned about increasing foot traffic through the store, increasing storefront visibility, having desired goods in stock, having goods that appeal to customers, and having an appealing interior design, for example.

To more effectively sell their goods, retailers may attempt to appeal to specific customer segments of an overall market. Customer segments may be based on demographic criteria such as age, gender, family size, and income, for example. Customers of a customer segment are those who meet the demographic criteria of the customer segment. Retailers may also wish to monitor how customers of each customer segment act within their stores so that the retailers may determine how to more effectively configure their stores.

### SUMMARY

One embodiment is a system for providing a guided walkthrough of a retail store to a user. The system receives at least one criteria. The at least one criteria defines a customer segment. The customer segment corresponds to a set of customers of the store. The system also determines a representative path. The representative path is determined based upon paths previously taken through the store by the set of customers. The system also transmits instructions to guide the user along the representative path.

### BRIEF DESCRIPTION OF THE DRAWINGS

FIG. 1 is an overview block diagram of a computer system for providing a guided walkthrough of a retail store in accordance with an embodiment of the present invention.

FIG. 2 is an overview block diagram of a system for identifying a representative path taken through a store in accordance with one embodiment.

FIG. 3 is a flow diagram of collecting information upon the tracking of a mobile device in accordance with one embodiment.

FIG. 4(a) illustrates a type of information that may be collected from a customer in accordance with one embodiment.

FIG. 4(b) illustrates a type of information that may be collected from a customer in accordance with another embodiment.

FIG. 4(c) illustrates a type of information that may be collected from a customer in accordance with another embodiment.

FIG. 4(d) illustrates a type of information that may be collected from a customer in accordance with another embodiment.

FIG. 5 is an overview block diagram of a system for providing a guided walkthrough of a retail store in accordance with one embodiment.

FIG. 6 is a flow diagram of providing a guided walkthrough of a retail store in accordance with one embodiment.

FIG. 7 is a flow diagram of providing a guided walkthrough of a retail store in accordance with one embodiment.

FIG. 8 is a screen shot of a user receiving a guided walkthrough and receiving business intelligence data in accordance with one embodiment.

FIG. 9 is a flow diagram of providing a guided walkthrough of a retail store in accordance with another embodiment.

### DETAILED DESCRIPTION

One embodiment is a system that provides a user with a guided walkthrough of a retail store. The user may be, but is not limited to being, a retail executive, a manager, and/or a retailer of the retail store. The user is guided through the retail store along a specific path. The specific path may be a representative path that corresponds to a path taken by a customer of the retail store. By following the specific path through the retail store, the user may understand how a customer walks, shops, and views the retail store. In one embodiment, as the user moves along the path shown by the guided walkthrough, relevant business intelligence data may also be presented to the user. The business intelligence data may be related to the location of the store that is currently viewed by the user along the representative path and/or the market segment related to that representative path.

In order to understand customer behavior, retailers may try to mine data relating to their customers' shopping trends and may then study that data through tools such as business intelligence reports or spreadsheets. Although these tools may provide insights into different trends and into different statistical correlations relating to purchasing behavior, these tools lack other contextual information that would be gained by the retailers if the retailers were able walk through their own stores from the perspective of the customers.

Retailers have also traditionally relied on information gathered from surveys, video analytics, and the tracking of customers' mobile devices in stores. However, these approaches, by themselves, still do not clearly provide the contextual information sought by retailers that would be gained by experiencing the shopping experience from the perspective of a representative customer of a given customer segment.

In general, the results produced by the previous approaches are divorced from the reality of customer experience in the stores. The previous approaches also are not able to provide insights which are derived from unstructured data about the store experience, or insights derived from the absence of certain customer actions.

In contrast to the previous approaches, one embodiment is directed to simulating shopping at a store from the perspective of a customer. By providing a walkthrough of a store from the perspective of a customer, one embodiment provides the user with the ability to view traditional business intelligence (“BI”) data through the lens of customer experience, thus allowing the user to make decisions in view of the context surrounding their business data. Embodiments may provide users with a clear view of how their customers actually shop in retail stores. Users may receive a clear view of how a wide variety of factors impact the customer experience.

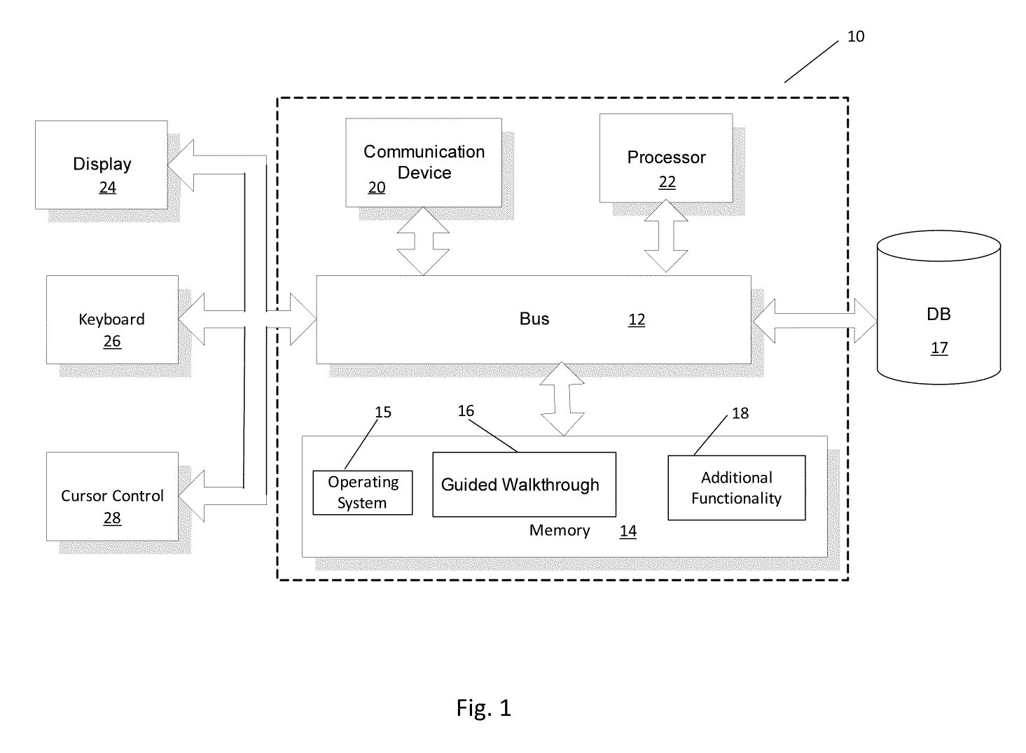

FIG. 1 is an overview block diagram of a computer system 10 for providing a guided walkthrough of a retail store in accordance with an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other known method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 may be further coupled via bus 12 to a display 24, such as a Liquid Crystal Display (“LCD”). A keyboard 26 and a cursor control device 28, such as a computer mouse, may be further coupled to bus 12 to enable a user to interface with system 10.

In one embodiment, memory 14 stores software modules that provide functionality when executed by processor 22. The modules include an operating system 15 that provides operating system functionality for system 10. The modules further include guided walkthrough module 16 for a guided walkthrough providing system that provides a user with a guided walkthrough of a retail store along a specific path, as disclosed in more detail below. System 10 can be part of a larger system such as an enterprise resource planning system, for example. Therefore, system 10 will typically include one or more additional functional modules 18 to include additional functionality, such as data processing functionality for configuring or deploying resources. A database 17 is coupled to bus 12 to store data used with modules 16 and 18.

In one embodiment, a determined representative path may be shown in a playback that guides a user through a store with turn-by-turn instructions. The turn-by-turn instructions may also instruct the user to pause at certain points along the representative path. The pauses may correspond to pauses taken by a customer whose actions are represented by the representative path. The playback may also be paused and replayed by the user. The user may be guided by the playback while the user looks through a camera feed. In one embodiment, BI data relating to a particular customer market segment may be overlaid on the items and store areas visible in the camera feed seen by the user. The BI data may relate to the visible items or store areas, as seen by the user. This guided walkthrough provides a user with contextual information that the user would lack should the user merely read business intelligence reports about a customer segment's purchasing patterns in a given store. Embodiments of the present invention may help a user to identify issues that cannot be expressed easily via business reports alone.

In one embodiment, a user may walk through a store from the perspective of a customer, of a particular customer segment, at a particular time. For example, suppose that a user wants to identify why a store is not achieving expected sales from a customer segment corresponding to “new mothers.” The user may arrive at a nearby store and choose to walk through the store from the perspective of a “new mother” as the “new mother” customer would shop on a Saturday morning. One embodiment would then take the user through the store along the representative path of this type of customer, showing overlays of sales data on the shelves as the user progresses through the store.

Suppose that a representative path indicates that a customer of a particular customer segment has lengthy pauses at a few points along the path, but the sales data does not reflect any purchases (or reflects very few purchases) for that customer segment at that particular time and location. The user may further investigate the reasons behind this customer behavior. For example, the user may pause the playback and activate a business intelligence filter to show stock-outs (i.e., items that are out of stock) for that area of the store. Using these functions, the user may find that certain products are common stock-outs at a particular time. For instance, the user may find that certain brands of diapers and certain brands of diet cola are common stock-outs towards the end of the week at those areas of the store.

In view of the above, the user may gain a better understanding of which customer segments are affected by particular stock-outs, and the user may thus make a better-informed decision on how to manage those stock-outs. As another example, a user may find that a product sells better in other stores compared to a present store. By using embodiments of the present invention, the user may discover that the difference in sales can be attributable to the product having been hidden behind a column in the present store, for example. In another example, the user may discover that a particular product suffers from below-average sales in a particular store because the product has been located in a cluttered area of the store. In view of these examples, an embodiment of the present invention may provide insights that are difficult to gain/ascertain from prepared spreadsheets or reports. For example, one embodiment may provide insights that are ascertained from negative data (e.g., data based upon events that do not occur), or from correlations within the collected data that are simply not tracked at all.

In other words, embodiments may allow a user to determine/derive information from events that do not occur. For example, the pausing of customers at a particular location in view of sales which do not occur may indicate stock-outs of certain products. Embodiments may also allow a user to correlate data to variables within the store that are not tracked. For example, the user may be able to ascertain that sales are suffering due to a cluttered store even though the level of clutter is not tracked for the store. One embodiment of the invention, in addition to allowing a user to have contextual/perspective information to accompany business data, also may help the user to identify relevant data which may not readily appear upon performing regression analysis.

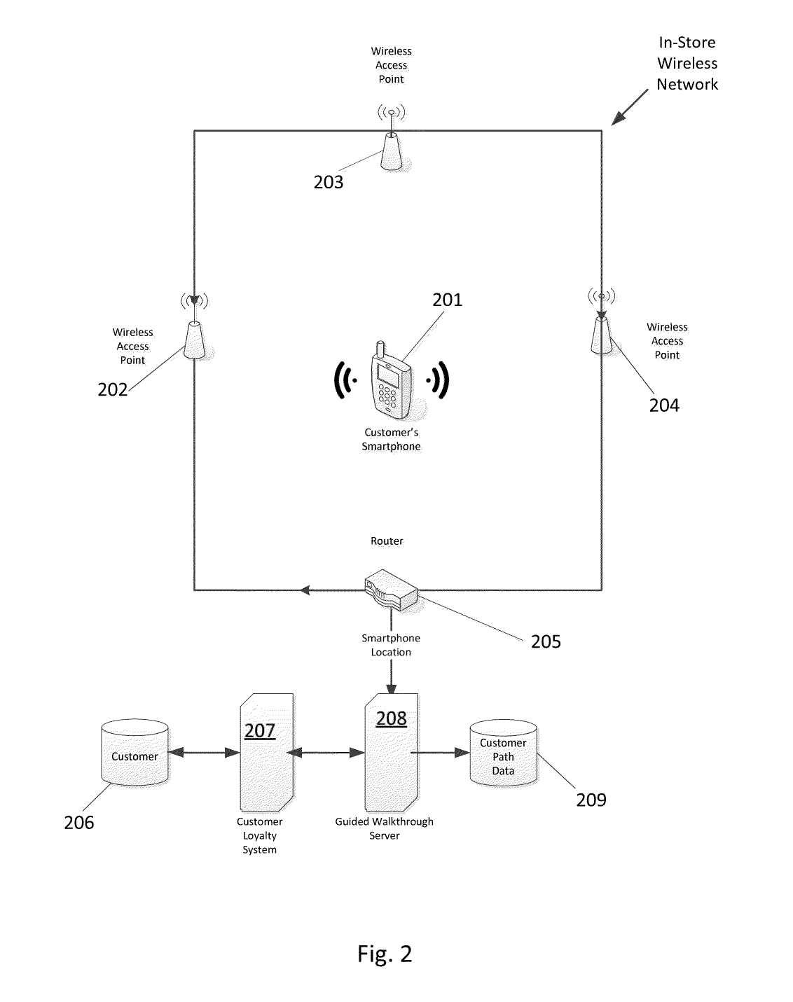

FIG. 2 is an overview block diagram of a system for identifying a representative path taken through a store in accordance with one embodiment. One embodiment may allow representative paths taken through the store by particular customer segments to be identified by using information collected from tracking mobile devices 201. Mobile device 201 may belong to a customer who has “opted-in” to being tracked.

Mobile device 201 may be tracked by wireless access points (202, 203, and 204). These wireless access points may form a wireless network. In one embodiment, the wireless access points transmit the collected information to a router 205. Router 205 may then transmit the collected information to guided walkthrough server 208 and/or customer loyalty system 207. Customer loyalty system 207 may access a customer database 206 to store the collected information in association with an appropriate customer. Customer loyalty system may also access customer database 206 to ensure that mobile device 201 belongs to a customer who has opted-in to being tracked. A customer may opt into a store's loyalty program to register the customer's mobile device's machine identification. An incentive for the customer to opt-in may be an offer of benefits to the customer such as an automatic check-in to the store to provide the customer with loyalty points or access to unique promotions. The opt-in registration includes creating a customer profile, including inputting demographic information of the customer. Customer loyalty system 207 is provided with a link between each mobile device and each corresponding customer, and through that to their shopping history and associated market segments that are associated with the customers. Guided walkthrough server 208 may access customer path database 209 to store customer paths derived from the information collected from mobile device 201. In one embodiment, guided walkthrough server 208 and customer loyalty system 207 can be implemented by computer system 10 of FIG. 1. In another embodiment, guided walkthrough server 208 and customer loyalty system 207 operate in conjunction with computer system 10. In one embodiment, customer database 206 and customer path database 209 correspond to database 17 of FIG. 1. In another embodiment, customer database 206 and customer path database 209 operate in conjunction with database 17.

Wireless access points (202, 203, and 204) in one embodiment are part of a system for providing indoor location functionality that tracks the position of mobile devices or smartphones, such as a “Micro-Location” system from NearBuy Systems. Wireless access points (202, 203, and 204) are a portion of the infrastructure, and the software functionality can be implemented by a server. Embodiments can provide the location of each customer with a minimum of one meter accuracy. Therefore, a server is able to track individual machine identification routes and locations throughout a store.

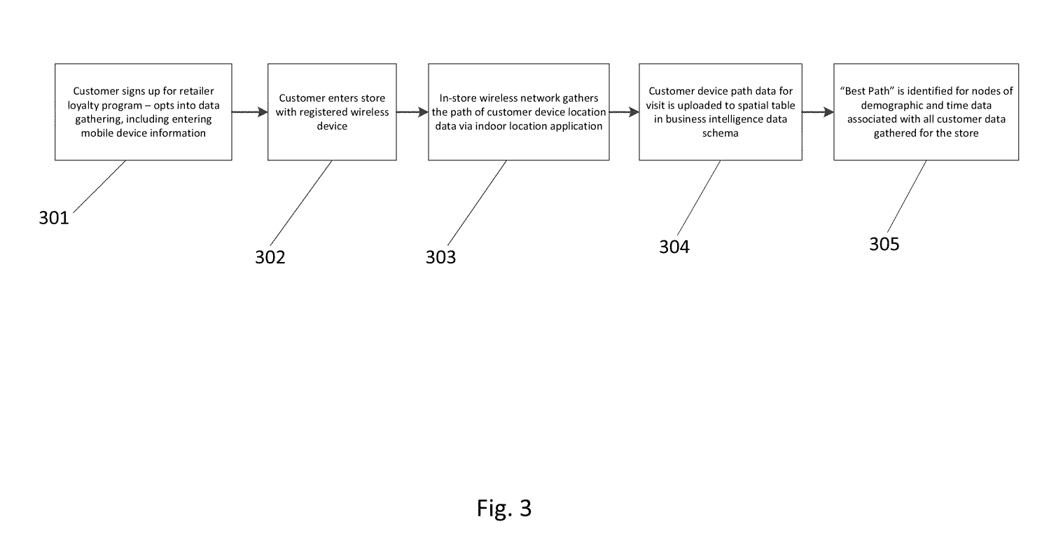

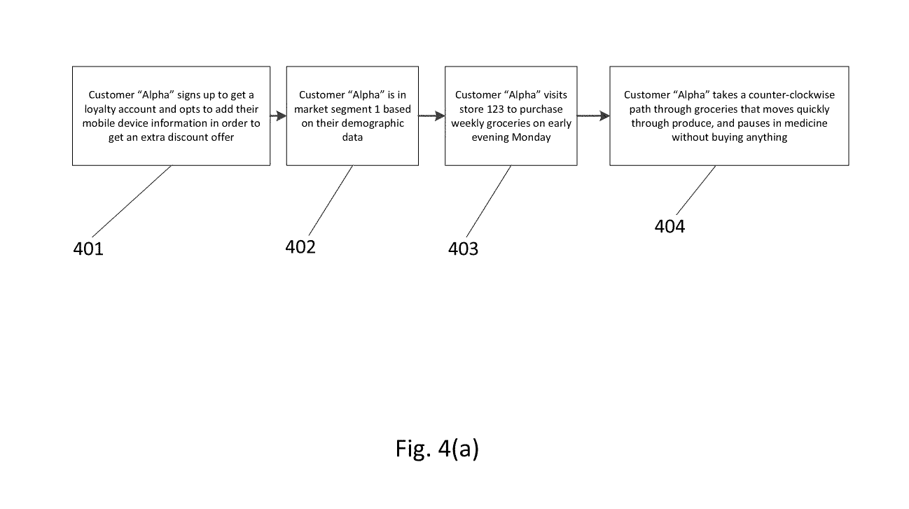

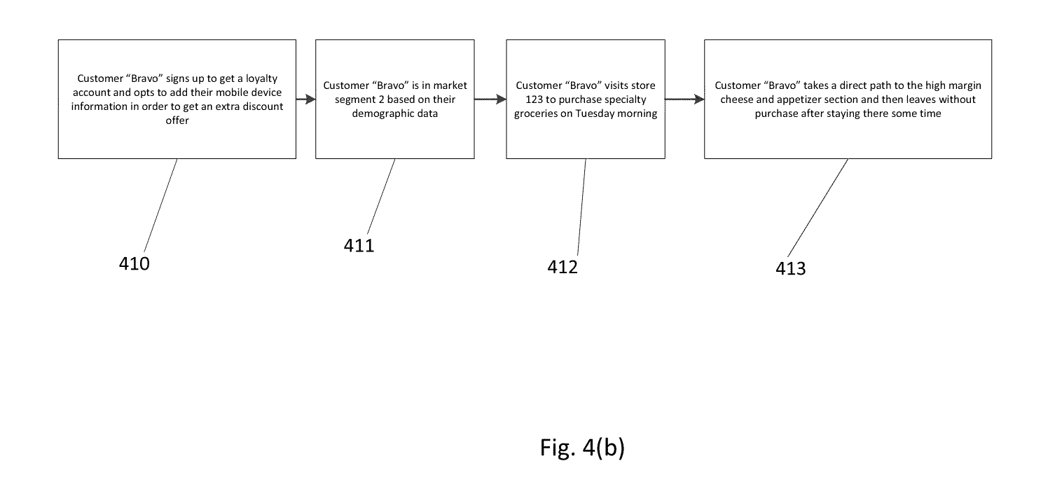

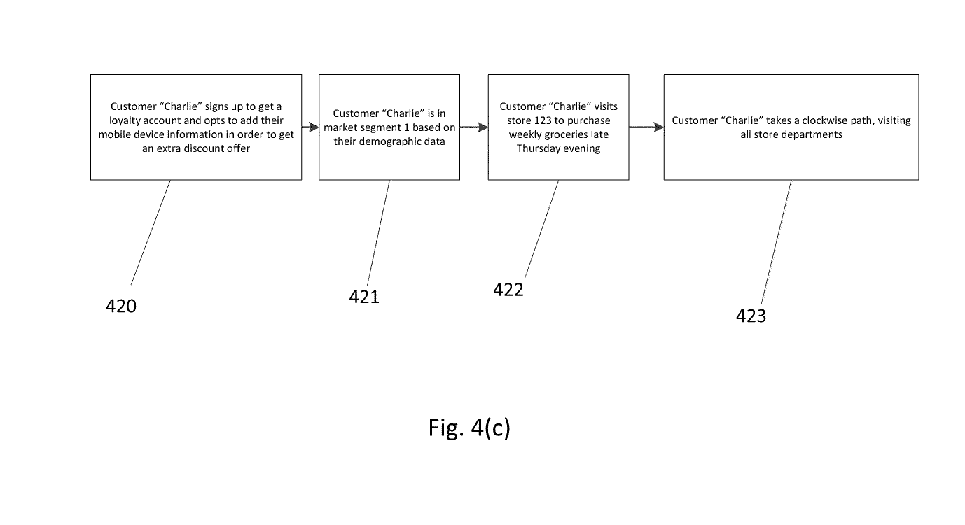

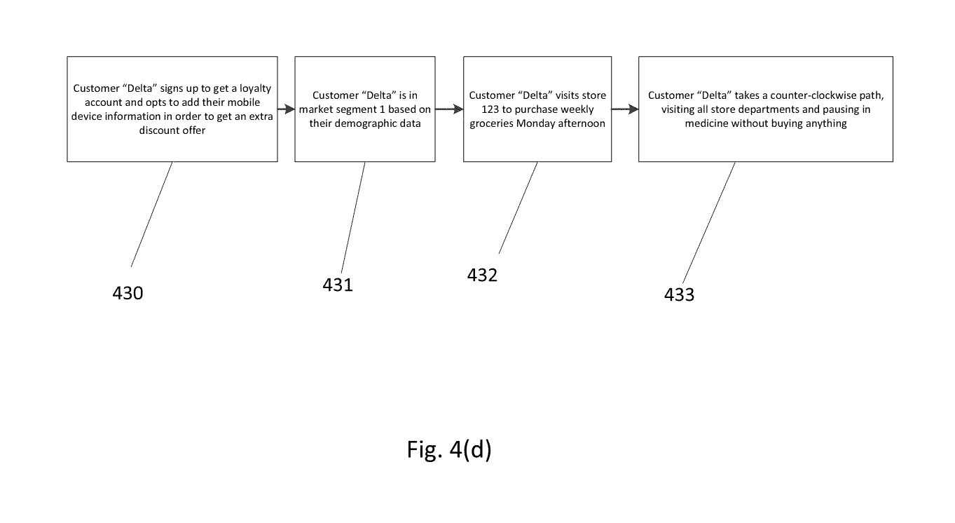

FIG. 3 is a flow diagram of collecting information upon the tracking of a mobile device 201 in accordance with one embodiment. In one embodiment, the functionality of the flow diagram of FIG. 3, and functionality of the flow diagrams of FIGS. 4(a)-(d), 6, 7, and 9 below, is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA,” etc.)), or any combination of hardware and software.

At 301, as described above, a customer may sign up for a retailer's loyalty program and allow the retailer to gather information from the customer's mobile device. At 302, the customer may enter the retailer's store with the mobile device. As described above, at 303, a wireless network may gather information from the mobile device. For example, referring to FIG. 2, wireless access points 202, 203, and 204 may gather information from mobile device 201. Referring again to FIG. 3, at 304, the path followed by the customer within the store is tracked and stored. Information relating to pauses in the path taken by the customer may be tracked and stored as well. For example, in one embodiment, the path may be stored within a table such as a spatial table provided by “Oracle Spatial” from Oracle Corp. At 305, one embodiment may determine representative paths based upon the demographic and time criteria of the newly stored path.

In view of the above, an embodiment provides functionality to collect indoor location data that is linked with demographic and market segment data associated with a customer. The collected data may indicate a specific date/time as well as well as individual store dimensions. Such functionality may be provided by an Oracle Spatial section, for example.

FIG. 4(a) illustrates a type of information that may be collected from a customer in accordance with one embodiment. For example, at 401, customer “Alpha” signs up to get a loyalty account. Customer “Alpha” also opts-in to having its mobile device information tracked in order to get an extra discount offer, for example. At 402, one embodiment may determine a market segment for the customer. For example, one embodiment may determine that customer “Alpha” is within “market segment 1” based on the demographic data of customer “Alpha.” At 403, one embodiment may collect information relating to where a customer shops, at what times, and at what frequency. For example, one embodiment may collect information which indicates that customer “Alpha” visits “store 123” to purchase weekly groceries during the early evening hours on Mondays. At 404, one embodiment may collect information relating to the path of a customer through a store. The information relating to the path of the customer may include information relating to the speed at which the customer moves along the path as well any pauses taken by the customer while moving along the path. For example, one embodiment may record that customer “Alpha” takes a counter-clockwise path through a groceries section, then moves quickly through a produce section, and then pauses in a medicine section without buying anything.

FIG. 4(b) illustrates a type of information that may be collected from a customer in accordance with another embodiment. At 410, similar to customer “Alpha” as shown in FIG. 4(a), customer “Bravo” signs up to get a loyalty account. Customer “Bravo” also opts-into having its mobile device information tracked in order to get an extra discount offer, for example. At 411, one embodiment may determine a market segment for a customer. For example, one embodiment may collect information and may indicate that customer “Bravo” is in “market segment 2,” based on the demographic data of customer “Bravo.” At 412, one embodiment may collect information relating to where a customer shops, what the customer shops for, and at what times. For example, one embodiment may collect information that indicates that customer “Bravo” visits “store 123” to purchase specialty groceries on a Tuesday morning. At 413, one embodiment may collect information relating to the path of a customer through a store. For example, one embodiment may record that customer “Bravo” takes a direct path to a high-margin cheese and appetizer section and then leaves without purchasing anything after staying there some time.

FIG. 4(c) illustrates a type of information that may be collected from a customer in accordance with another embodiment. At 420, customer “Charlie” signs up to get a loyalty account. Customer “Charlie” also opts-in to having its mobile device information tracked in order to get an extra discount offer, for example. At 421, one embodiment may determine a market segment for the customer. For example, one embodiment may determine that customer “Charlie” is within a “market segment 1” based on the demographic data of customer “Charlie.” At 422, one embodiment may collect information relating to where a customer shops, at what times, and at what frequency. For example, one embodiment may collect information which indicates that customer “Charlie” visits “store 123” to purchase weekly groceries late on a Thursday evening. At 423, one embodiment may collect information relating to the path of a customer through a store, and relating to the departments visited. For example, one embodiment may collect information indicating that customer “Charlie” takes a clockwise path to visit all store departments.

FIG. 4(d) illustrates a type of information that may be collected from a customer in accordance with another embodiment. At 430, customer “Delta” signs up to get a loyalty account. Customer “Delta” also opts-into having its mobile device information tracked in order to get an extra discount offer, for example. At 431, one embodiment may determine a market segment for the customer. For example, one embodiment may determine that customer “Delta” is within “market segment 1” based on the demographic data of customer “Delta.” At 432, one embodiment may collect information relating to where a customer shops, at what times, and at what frequency. For example, one embodiment may collect information which indicates that customer “Delta” visits store 123 to purchase weekly groceries on a Monday afternoon. At 433, one embodiment may collect information relating to the path of a customer through a store, and relating to which departments are visited. For example, one embodiment may collect information indicating that customer “Delta” takes a counter-clockwise path, visits all store departments, and pauses in a medicine department without buying anything.

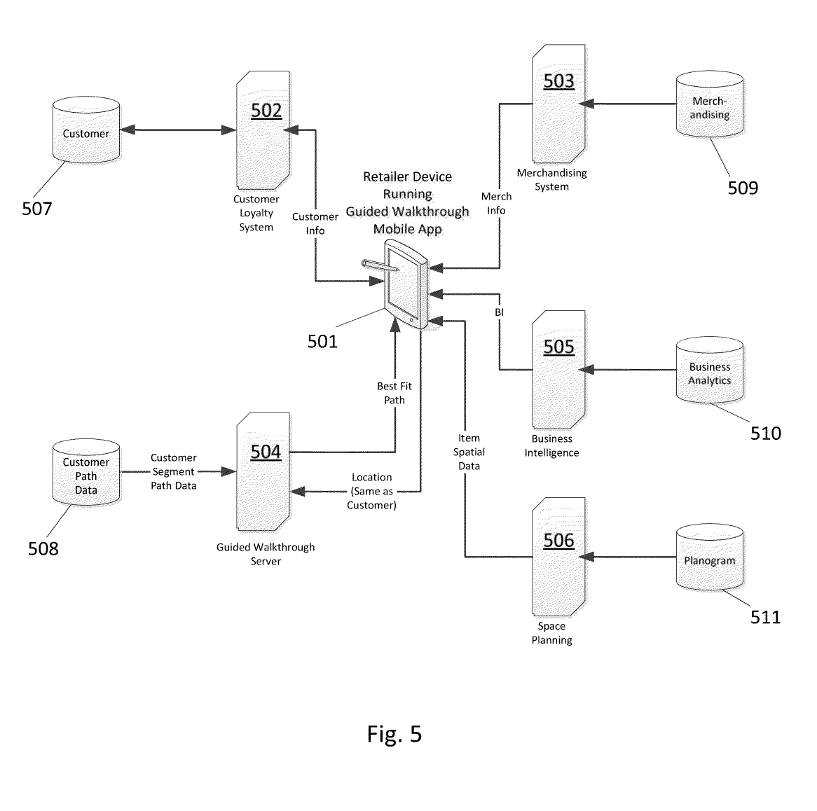

FIG. 5 is an overview block diagram of a system for providing a guided walkthrough of a retail store in accordance with one embodiment. A viewing device 501 provides a user with a guided walkthrough. The viewing device 501 may be a smartphone or a tablet, for example. In one embodiment, the viewing device 501 may run a mobile application that performs the functionality of providing a user with a guided walkthrough.

As described above, customers of a retail store may register to have a loyalty account with the retail store. Viewing device 501 may access the loyalty account information corresponding to the registered loyalty accounts via customer loyalty system 502 and customer database 507. Loyalty information may track the purchases of the customers. Loyalty information may also indicate the market segment for each of the customers.

In one embodiment, as previously described, customers may decide to opt-in to allow their mobile devices to be tracked because the retail store may offer such customers a direct benefit, such as: promotions that show on their mobile devices when they enter related areas, the ability to be shown active turn-by-turn instructions to get to a product, and/or interactive, optimized routing to all items on their shopping list, for example.

In one embodiment, viewing device 501 may access merchandising information from merchandising system 503 and from merchandising database 509. The merchandising information may include current data about items and stores, such as store addresses.

By using viewing device 501, a user may access BI data from business intelligence system 505. In one embodiment, the BI data may include business intelligence reports, such as business intelligence reports provided by Oracle Retail Business Intelligence, for example. The BI data may include information relating to different market segments, sales histories of different customers, stock-outs of different products, forecasts of customer behavior, future purchase orders, and other customer and supply-chain data, for example. As previously described, BI data may be presented to the user via viewing device 501 as the user moves along a representative path through the store.

By using viewing device 501, a user may access a planogram of a retail store via space planning system 506 and via planogram database 511. A planogram may generally be a visual representation of a store's products and/or services. Planograms may also represent the configuration of products on store shelves. Planogram database 511 may be a spatial data storage such as used in Oracle Spatial. The stored information in Oracle Spatial can be accessible remotely through web services. The planogram of a particular store may include information relating to the items of the store at each location within the store. Route information provided by one embodiment may be layered on top of the planogram so that the user may examine the corresponding BI for each location of the store. For example, once a representative path is layered on a planogram, one embodiment may present BI data that corresponds to the location/items seen by the user (along the representative path).

In one embodiment, the functionality for tracking a wireless signal plus other data is performed by an indoor location system. One embodiment may use an indoor location system provided by NearBuy Systems, for example. Guided walkthrough server 504, which operates in conjunction with customer path database 508, automatically identifies representative paths taken by representative customers for a given store. The path for a particular customer segment at a particular date/time may be chosen. Customer routes through the store will be stored in the customer path database 508 as a series of coordinates constituting, in aggregate, their paths through the store. These coordinates will be associated with date, time, and a customer identifier, and will be separated in time by a configurable delay in how often position information of a customer is gathered while the customer is in the store. Using configurable location precision to allow for close paths to be deemed similar, the most “popular” route of a combination of coordinate-to-coordinate segments can be calculated through the store based on a filtered set of paths. Identifying the representative path may correspond to one or a combination of the following: (1) using the calculated “popular” path based on the set of paths matching the customer, location, and time/date criteria; (2) a path chosen of a single customer who has the most route segments that match the most popular route segments; and/or (3) both single and merged customer paths could be weighted based on how much they spend or based on other tracked factors.

One embodiment may also include an augmented reality (“AR”) package. For example, one embodiment may include an AR package such as an AR application from metaio Corp., for example. The AR package may overlay data on a viewfinder of viewing device 501. The overlaid data may be appropriate/relevant for a particular area of a store which the user is in. The AR package may also overlay item information on items of the shelves, shelves which are viewed by the user. Area overlays that show a data image which tracks over entire store departments in the viewfinder may be based on combining a current device location with a planogram of a store, while item overlays that show a data image that tracks over individual items may rely on either image recognition provided by the AR package or on placing AR tags on shelf edges.

In one embodiment, when a user uses viewing device 501 to receive a guided walkthrough along a representative path, the location of the store may be identified automatically via a global positioning system (“GPS”). The location and movement of the user within the store may be determined by a third-party indoor location system, such as that provided by NearBuy Systems. The user may then be instructed by a viewfinder to walk along a bearing shown through a compass pointer for a given period of time. The user may be taken through turns using the compass pointer, and the user may be shown when and where to pause for a given amount of time. In other words, the viewfinder may display a playback of the representative path. In one embodiment, the user may pause the playback at any time. The user may also choose what BI data is overlaid on the viewfinder. In one embodiment, the BI defaults to data for the market segment that corresponds to the representative path. The user may change the displayed BI data by changing filter settings. By using a planogram of a store for which the walkthrough is provided for, one embodiment may overlay aisle or store area data onto the view finder. The embodiment may also use image recognition or AR tags so that individual-item-data can be overlaid on items on the shelves, such as plan versus sales, stock-out statistics, loss prevention statistics, or segment purchasing trends. One embodiment would automatically display high correlation data (e.g., to show the user which products are typically purchased together by a chosen segment).

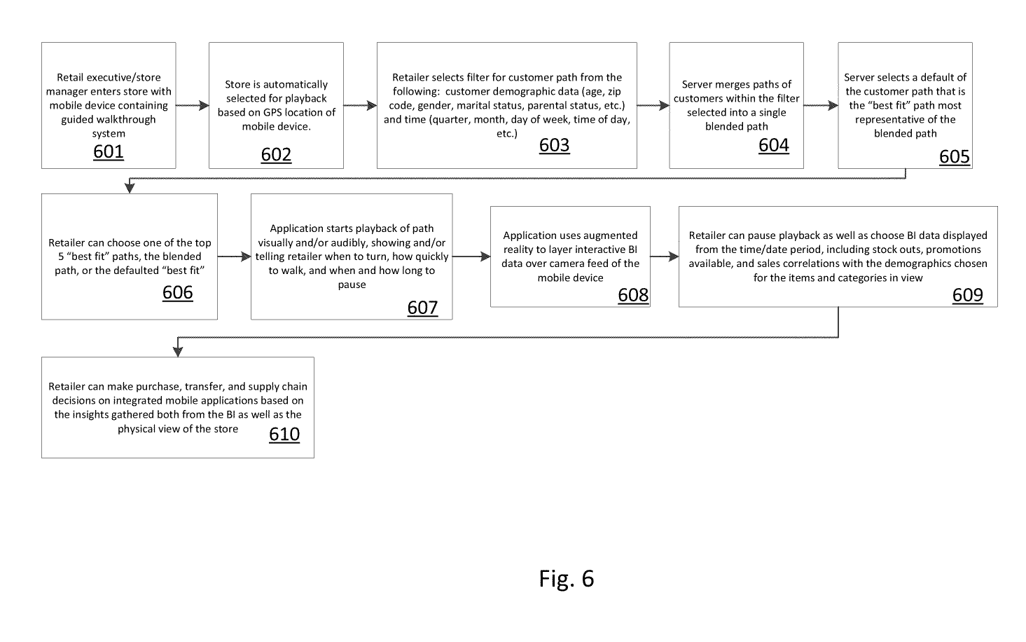

FIG. 6 is a flow diagram of providing a guided walkthrough of a retail store in accordance with one embodiment. At 601, a user enters a store with a viewing device that can perform the functionality of providing a guided walkthrough. For example, the user may be a retailer. The viewing device may be a mobile device of the retailer. At 602, one embodiment may automatically determine the store for which the guided walkthrough is provided for. The store may be automatically selected for playback of a representative path based on a GPS location of the viewing device of the user. At 603, a user may identify the type of representative path that is of interest to the user. For example, the user may designate different criteria for the representative path by selecting filters to filter/find a representative path that meets the designated criteria. The different criteria by which to filter/find the representative path include customer demographic data (e.g., age, zip code, gender, marital status, parental status, etc.) and time data (e.g., quarter, month, day of week, time of day, etc.), for example. In other words, the different criteria may define different customer segments. At 604, in one embodiment, upon receiving the criteria for determining the representative path, a server may merge paths of customers meeting the criteria of the filter into a single blended path. At 605, one embodiment selects the one customer path that is most representative of the blended path. This “best fit” path may be set as the default representative path. At 606, the user may also choose one of the top 5 “best fit” paths (which include other customer paths that may represent the blended path), the blended path itself, or the defaulted “best fit” path. At 607, one embodiment may start playback of the representative path visually and/or audibly, showing and/or telling the user when to turn, how quickly to walk, and when and how long to pause. At 608, one embodiment uses augmented reality to layer interactive BI data over a camera feed of the mobile device. As previously described, the BI data may be related to the items/areas currently viewed by the user. At 609, a user may pause playback of the representative path as well as choose to display BI data according to a particular time, date, and place. The user may also display information relating to stock-outs, available promotions, and sales correlations with the demographic chosen for the items and categories in view. At 610, a user can make purchase, transfer, and supply-chain decisions on integrated mobile applications based upon the insights gathered from both the BI data as well as the user's physical viewing of the store.

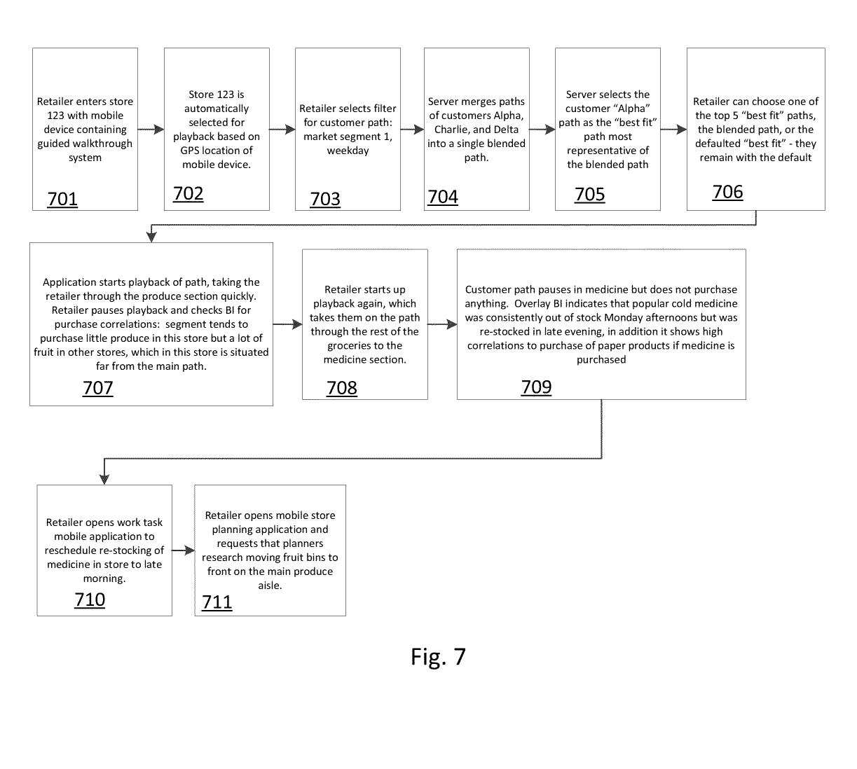

FIG. 7 is a flow diagram of providing a guided walkthrough of a retail store in accordance with one embodiment. At 701, a user enters a store with a viewing device that can perform the functionality of providing a guided walkthrough. For example, the user may be a retailer that enters store “123” with a mobile device containing a guided walkthrough system. At 702, one embodiment may automatically determine the store for which the guided walkthrough is provided for. For example, in one embodiment, store 123 is automatically selected for playback based on a GPS location of a mobile device. At 703, a user may identify the type of representative path that is of interest to the user. For example, a retailer may select a filter for a customer path that filters by criteria corresponding to “Market segment 1” on a “weekday.” At 704, one embodiment merges paths of different customers who meet the criteria of the filter. For example, one embodiment merges paths of customers “Alpha,” “Charlie,” and “Delta” into a single blended path. At 705, one embodiment selects the one customer path that is the most representative of the blended path. For example, a server may select the path of customer “Alpha” as the “best fit” path that is most representative of the blended path. At 706, the user may choose from a plurality of top “best fit” paths, the blended path itself, or a defaulted “best fit.” In the example of FIG. 7, suppose that the user remains with the default “best fit” path. At 707, in one embodiment, the user may start playback of the selected path. For example, the retailer may be taken along a path that moves through a produce section quickly. The retailer may pause the playback and check BI data for purchase correlations. The retailer may determine that the examined customer segment tends to purchase little produce in this store but a lot of fruit in other stores. The retailer may ascertain that, in this store, the fruit is situated far from the main path. At 708, the retailer may start up the playback again, which takes the retailer on a path through the rest of the groceries to a medicine section. At 709, suppose that the customer path pauses in the medicine section but does not purchase anything. The retailer may use overlaid BI data to ascertain that a popular cold medicine was consistently out of stock on Monday afternoons but was re-stocked in late evening. In addition, the retailer may identify that there is a high correlation between the purchase of paper products and the purchase of medicine. At 710, the retailer may open a work task mobile application to reschedule re-stocking of medicine in this store to late morning, as opposed to late evening. At 711, the retailer may also open a mobile store planning application and request that planners research moving fruit bins to the front of the main produce aisle.

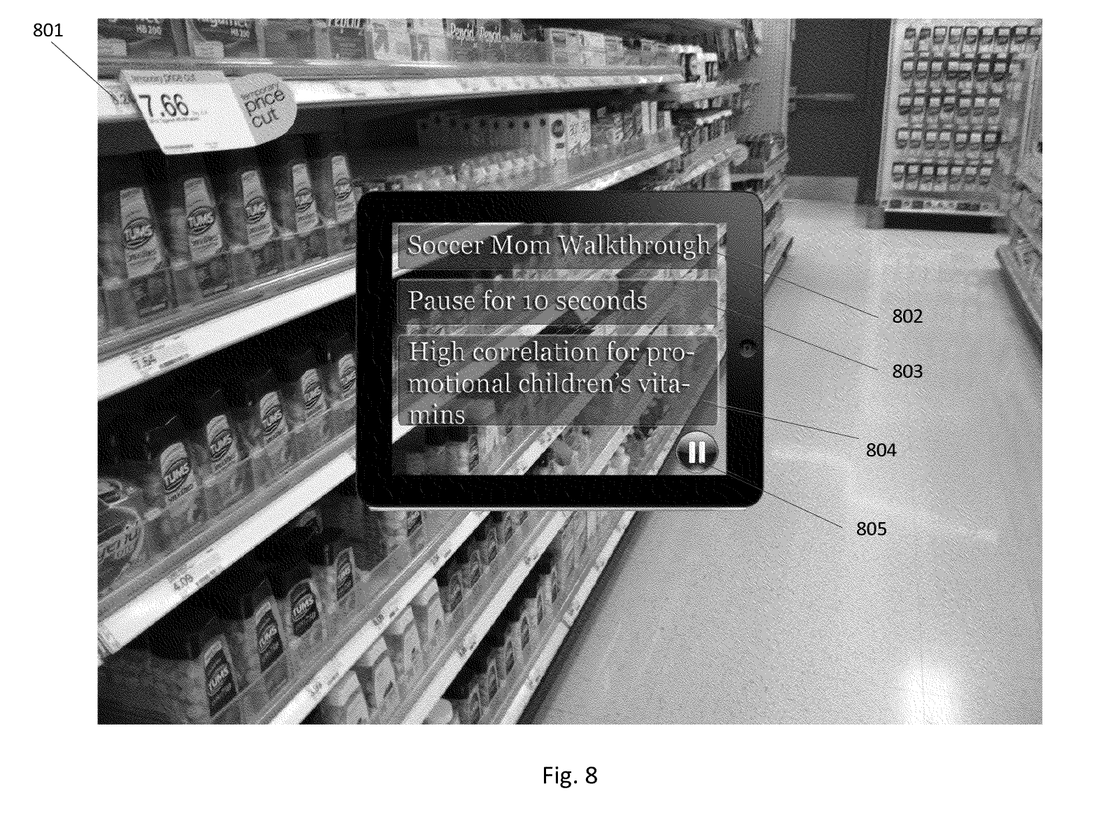

FIG. 8 is a screen shot 801 of a user receiving a guided walkthrough and receiving BI data in accordance with one embodiment. Screen shot 801 may include customer segment information 802 relating to the customer segment that is being displayed. The representative path may include pauses taken by the particular customer segments while moving through the store. Information relating to the pauses 803 may be shown as well. BI data 804 may also be shown on the screen. The playback may also be stopped or resumed via button 805.

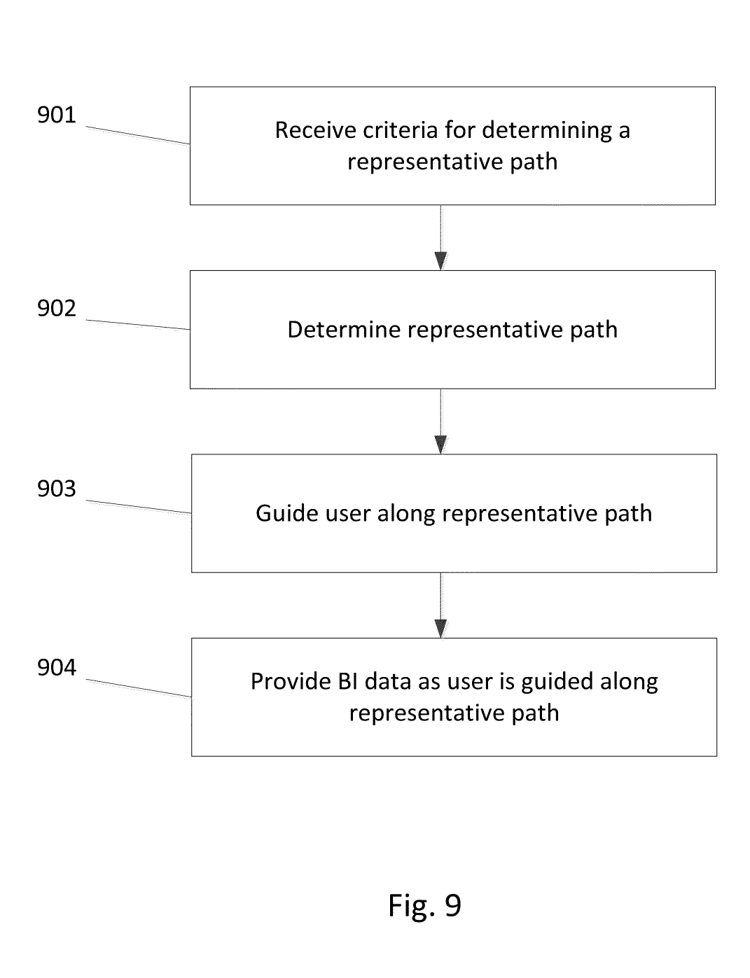

FIG. 9 is a flow diagram of providing a guided walkthrough of a retail store in accordance with another embodiment. At 901, criteria for determining a representative path is received. As previously described, a user may provide criteria for a representative path by selecting the corresponding criteria in a filter. The selectable criteria include, but are not limited to, demographic data and data relating to time. The criteria may define a customer segment.

At 902, a representative path is determined based upon the received criteria. As previously described, the representative path may correspond to one of a plurality of “best fit paths” or a blended path, for example.

At 903, a user is guided along the representative path. As previously discussed, the user may be guided by a playback of the representative path. The user may be guided along the representative path by using visual and/or audio instructions/cues. The instructions may tell the user where to turn, how quickly to walk, when to pause, and how long to pause, for example.

At 904, BI data is provided to the user as the user is guided along the representative path. As previously discussed, the BI data may include, but is not limited to, stock outs, available promotions, and sales correlations, for example.

As described above, embodiments are directed to a system that simulates shopping at a store from the perspective of a customer. By providing a walkthrough of a store from the perspective of a customer, the user may be provided with the ability to view their BI data through the lens of customer experience, thus allowing the user to make decisions based on the context surrounding the business data of the user. When providing the simulation of the shopping experience, business intelligence data about customer habits may be integrated into the simulation. Embodiments may provide users with a clear view of how their customers actually shop in retail stores.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, causes the processor to provide a guided walkthrough of a retail store to a user, the providing comprising:
receiving at least one criteria, wherein the at least one criteria defines a customer segment, and the customer segment corresponds to a set of customers of the store;
determining a representative path, wherein the representative path is determined based upon paths previously taken through the store by the set of customers; and
transmitting instructions to guide the user along the representative path.

2. The computer readable medium of claim 1, further comprising transmitting business intelligence information to the user as the user is guided along the representative path.

3. The computer readable medium of claim 1, wherein the at least one criteria comprises demographic information.

4. The computer readable medium of claim 1, wherein transmitting instructions to guide the user comprises instructing the user to pause on the representative path, and the pause corresponds to a pause taken by at least one customer of the set of customers.

5. The computer readable medium of claim 1, wherein determining the representative path comprises merging a plurality of paths taken by the set of customers.

6. The computer readable medium of claim 2, wherein transmitting the business intelligence information comprises transmitting business intelligence information that relates to a location that the user is at along the representative path.

7. The computer readable medium of claim 1, wherein each customer of the set of customers has a corresponding mobile device, and the paths previously taken through the store by the set of customers are determined by tracking the mobile devices while the set of customers moves through the store.

8. A method for providing a guided walkthrough of a retail store to a user, the method comprising:
receiving at least one criteria, wherein the at least one criteria defines a customer segment, and the customer segment corresponds to a set of customers of the store;
determining a representative path, wherein the representative path is determined based upon paths previously taken through the store by the set of customers; and
transmitting instructions to guide the user along the representative path.

9. The method of claim 8, further comprising transmitting business intelligence information to the user as the user is guided along the representative path.

10. The method of claim 8, wherein the at least one criteria comprises demographic information.

11. The method of claim 8, wherein transmitting instructions to guide the user comprises instructing the user to pause on the representative path, and the pause corresponds to a pause taken by at least one customer of the set of customers.

12. The method of claim 8, wherein determining the representative path comprises merging a plurality of paths taken by the set of customers.

13. The method of claim 9, wherein transmitting the business intelligence information comprises transmitting business intelligence information that relates to a location that the user is at along the representative path.

14. The method of claim 8, wherein each customer of the set of customers has a corresponding mobile device, and the paths previously taken through the store by the set of customers are determined by tracking the mobile devices while the set of customers moves through the store.

15. A system for providing a guided walkthrough of a retail store to a user, the system comprising:
a processor;
a memory coupled to the processor;
a receiving module that receives at least one criteria, wherein the at least one criteria defines a customer segment, and the customer segment corresponds to a set of customers of the store;
a determining module that determines a representative path, wherein the representative path is determined based upon paths previously taken through the store by the set of customers; and
a first transmitting module that transmits instructions to guide the user along the representative path.

16. The system of claim 15, further comprising a second transmitting module that transmits business intelligence information to the user as the user is guided along the representative path.

17. The system of claim 15, wherein the at least one criteria comprises demographic information.

18. The system of claim 15, wherein transmitting instructions to guide the user comprises instructing the user to pause on the representative path, and the pause corresponds to a pause taken by at least one customer of the set of customers.

19. The system of claim 15, wherein determining the representative path comprises merging a plurality of paths taken by the set of customers.

20. The system of claim 15, wherein each customer of the set of customers has a corresponding mobile device, and the paths previously taken through the store by the set of customers are determined by tracking the mobile devices while the set of customers moves through the store.
